(19) United States
(12) Patent Application Publication
(10) Pub. No.: US 2019/0010675 A1
(43) Pub. Date: Jan. 10, 2019

(54) SHOVEL

(71) Applicant: SUMITOMO HEAVY INDUSTRIES, LTD., Tokyo (JP)

(72) Inventors: Masaki OGAWA, Kanagawa (JP); Lei SHEN, Kanagawa (JP)

(21) Appl. No.: 16/131,184

(22) Filed: Sep. 14, 2018

Related U.S. Application Data
(63) Continuation of application No. PCT/JP2017/010488, filed on Mar. 15, 2017.

(30) Foreign Application Priority Data
Mar. 16, 2016 (JP) 2016-053006

(51) Int. Cl. E02F 3/36; E02F 3/32; E02F 9/00; G01B 7/16; G01C 9/02

(52) U.S. Cl. CPC E02F 3/36; E02F 3/32; E02F 9/00; H04B 1/02; G01C 9/02; G01B 2210/58; G01B 7/16

(57) ABSTRACT

A shovel includes an undercarriage, a rotating structure, an attachment, and a vibration-powered generator. The rotating structure is mounted on the undercarriage. The attachment is attached to the rotating structure. The vibration-powered generator is attached to one or more of the rotating structure, the undercarriage, and a work element of the attachment.

### CROSS-REFERENCE TO RELATED APPLICATIONS

This application is a continuation application filed under 35 U.S.C. 111(a) claiming benefit under 35 U.S.C. 120 and 365(c) of PCT International Application No. PCT/JP2017/010488, filed on Mar. 15, 2017 and designating the U.S., which claims priority to Japanese Patent Application No. 2016-053006, filed on Mar. 16, 2016. The entire contents of the foregoing applications are incorporated herein by reference.

### BACKGROUND

### Technical Field

The present invention generally relates to shovels.

### Description of Related Art

Shovels that include a strain gauge for overload detection attached to a boom attached to an upper rotating structure and reduce the flow rate of hydraulic oil toward a hydraulic cylinder when a load signal detected by the strain gauge exceeds a reference value during excavation work are known.

### SUMMARY

According to an aspect of the present invention, a shovel includes an undercarriage, a rotating structure, an attachment, and a vibration-powered generator. The rotating structure is mounted on the undercarriage. The attachment is attached to the rotating structure. The vibration-powered generator is attached to one or more of the rotating structure, the undercarriage, and a work element of the attachment.

It is to be understood that both the foregoing general description and the following detailed description are exemplary and explanatory and not restrictive of the invention.

### BRIEF DESCRIPTION OF THE DRAWINGS

FIG. 1 is a side view of a shovel according to an embodiment of the present invention;

FIG. 2 is a diagram illustrating a configuration of a drive system installed in the shovel of FIG. 1;

FIG. 3 is a diagram illustrating an excavating and loading motion;

FIG. 4 is a diagram illustrating a configuration of a controller;

FIG. 5 is a flowchart illustrating a flow of a weight deriving process;

FIG. 6 is a diagram illustrating an arrangement of a vibration-powered generator, a transmitter, and a strain sensor that are attached to a boom;

FIG. 7 is a diagram illustrating another arrangement of the vibration-powered generator, the transmitter, and the strain sensor that are attached to the boom;

FIG. 8 is a schematic diagram of a communications network to which the shovel of FIG. 1 connects;

FIG. 9 is a diagram illustrating an arrangement of the vibration-powered generator, the transmitter, and the strain sensor that are attached to an arm; and

FIG. 10 is a diagram illustrating an arrangement of the vibration-powered generator, the transmitter, and the strain sensor that are attached to a traveling undercarriage.

### DETAILED DESCRIPTION

Normally, a power supply such as a battery is mounted on the upper rotating structure of a shovel. As noted above, the strain gauge is attached to the boom of the shovel, which is a component external to the upper rotating structure. Therefore, to connect the strain gauge to the power supply, it is necessary to extend a cable from the boom to the upper rotating structure. In this case, however, there is no choice but to run the cable in such a manner as to allow dirt, rocks, etc., to contact the cable. Therefore, the breakage of the cable is likely to occur, and it may be impossible to stably obtain the output of the strain gauge.

According to an aspect of the present invention, a shovel in which the output of an electrical load connected to a remote object can be obtained with more stability is provided.

One or more embodiments of the present invention are described below with reference to the accompanying drawings.

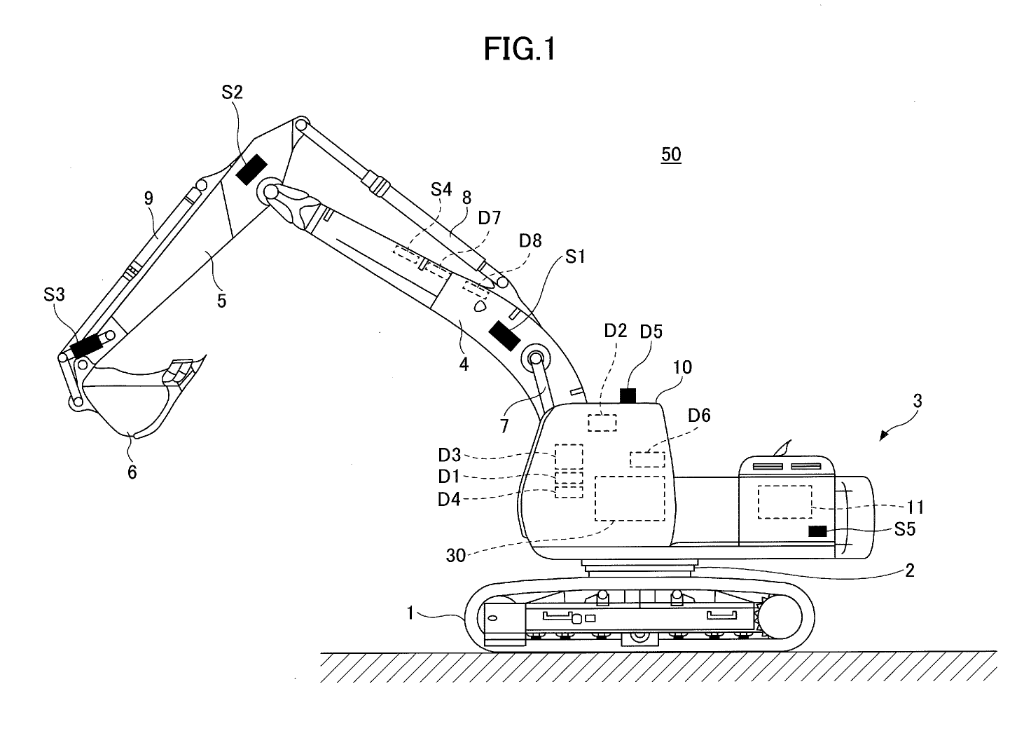

First, a shovel (an excavator) 50 that is a construction machine according to an embodiment of the present invention is described with reference to FIG. 1. FIG. 1 is a side view of the shovel 50. The shovel 50 includes a traveling undercarriage 1, a swing mechanism 2, and an upper rotating structure 3 mounted on the traveling undercarriage 1 via the swing mechanism 2. The shovel 50 further includes a boom 4 attached to the upper rotating structure 3, an arm 5 attached to the end of the boom 4, and a bucket 6, which is an end attachment, attached to the end of the arm 5. The boom 4, the arm 5, and the bucket 6 are work elements that form an excavation attachment.

The shovel 50 further includes a boom cylinder 7, an arm cylinder 8, and a bucket cylinder 9, which hydraulically drive the boom 4, the arm 5, and the bucket 6, respectively.

The shovel 50 further includes a boom angle sensor S1 attached to the boom 4, an arm angle sensor S2 attached to the arm 5, and a bucket angle sensor S3 attached to the bucket 6. The boom angle sensor S1, the arm angle sensor S2, and the bucket angle sensor S3 are collectively referred to as “posture sensor.”

The boom angle sensor S1 detects the rotation angle of the boom 4. The boom angle sensor S1 is, for example, an acceleration sensor that detects the rotation angle of the boom 4 relative to the upper rotating structure 3 by detecting the inclination of the boom 4 relative to a horizontal plane.

The arm angle sensor S2 detects the rotation angle of the arm 5. The arm angle sensor S2 is, for example, an acceleration sensor that detects the rotation angle of the arm 5 relative to the boom 4 by detecting the inclination of the arm 5 relative to a horizontal plane.

The bucket angle sensor S3 detects the rotation angle of the bucket 6. The bucket angle sensor S3 is, for example, an acceleration sensor that detects the rotation angle of the bucket 6 relative to the arm 5 by detecting the inclination of the bucket 6 relative to a horizontal plane. The boom angle sensor S1, the arm angle sensor S2, and the bucket angle sensor S3 may be potentiometers using a variable resistor, stroke sensors that detect the amount of stroke of a corresponding hydraulic cylinder, rotary encoders that detect a rotation angle about a connecting pin, and combinations of an acceleration sensor and a gyro sensor.

The shovel 50 further includes a strain sensor S4. According to this embodiment, the strain sensor S4 is a single-axis strain gauge attached inside the boom 4 to detect strain due to the tension or compression of the boom 4. The strain sensor S4 may alternatively be a three-axis strain gauge, multiple single-axis strain gauges attached to multiple locations inside the attachment, multiple three-axis strain gauges, or a combination of one or more single-axis strain gauges and one or more three-axis strain gauges. The strain sensor S4 may alternatively be attached to the outside surface of the boom 4.

The shovel 50 further includes a cabin 10 provided on the upper rotating structure 3, and power sources such as an engine 11 and a vehicle body tilt sensor S5 installed on the upper rotating structure 3. The shovel 50 further includes a controller 30, an input device D1, an audio output device D2, a display device D3, a storage device D4, and an engine controller D6, which are provided in the cabin 10. The shovel 50 further includes a communications device D5 provided outside the cabin 10.

The vehicle body tilt sensor S5 detects the tilt angle of the vehicle body of the shovel 50. According to this embodiment, the vehicle body tilt sensor S5 is an acceleration sensor that detects the tilt angle of the vehicle body relative to a horizontal plane. The tilt angle of the vehicle body may alternatively be derived from the outputs of strain gauges attached one to each of the upper, lower, left, and right inside surfaces of the boom 4, for example. In this case, the vehicle body tilt sensor S5 may be omitted.

The controller 30 is a control device that operates as a main control part to control the driving of the shovel 50. According to this embodiment, the controller 30 is composed of a processor that includes a central processing unit (CPU) and an internal memory. The CPU executes one or more programs stored in the internal memory to implement various functions of the controller 30.

The input device D1 is a device for an operator of the shovel 50 to input various kinds of information to the controller 30. The input device D1 includes, for example, a membrane switch provided on the surface of the display device D3. The input device D1 may also be a touchscreen or the like.

The audio output device D2 outputs various kinds of audio information in response to a command from the controller 30. The audio output device D2 is, for example, an in-vehicle loudspeaker connected to the controller 30. The audio output device D2 may alternatively be an alarm such as a buzzer.

The display device D3 displays an image including various kinds of work information in response to a command from the controller 30. The display device D3 is, for example, an in-vehicle liquid crystal display connected to the controller 30.

The storage device D4 stores various kinds of information. The storage device D4 is, for example, a non-volatile storage medium such as a semiconductor memory. According to this embodiment, the storage device D4 stores the detection values of the boom angle sensor S1, the arm angle sensor S2, the bucket angle sensor S3, the strain sensor S4, the vehicle body tilt sensor S5, etc., the output values of the controller 30, etc.

The communications device D5 controls radio communications between the controller 30 and a device external to the controller 30.

The engine controller D6 is a device that controls the engine 11. According to this embodiment, the engine controller D6 controls the amount of fuel injection, etc., to execute isochronous control to maintain the engine 11 at a predetermined rotational speed.

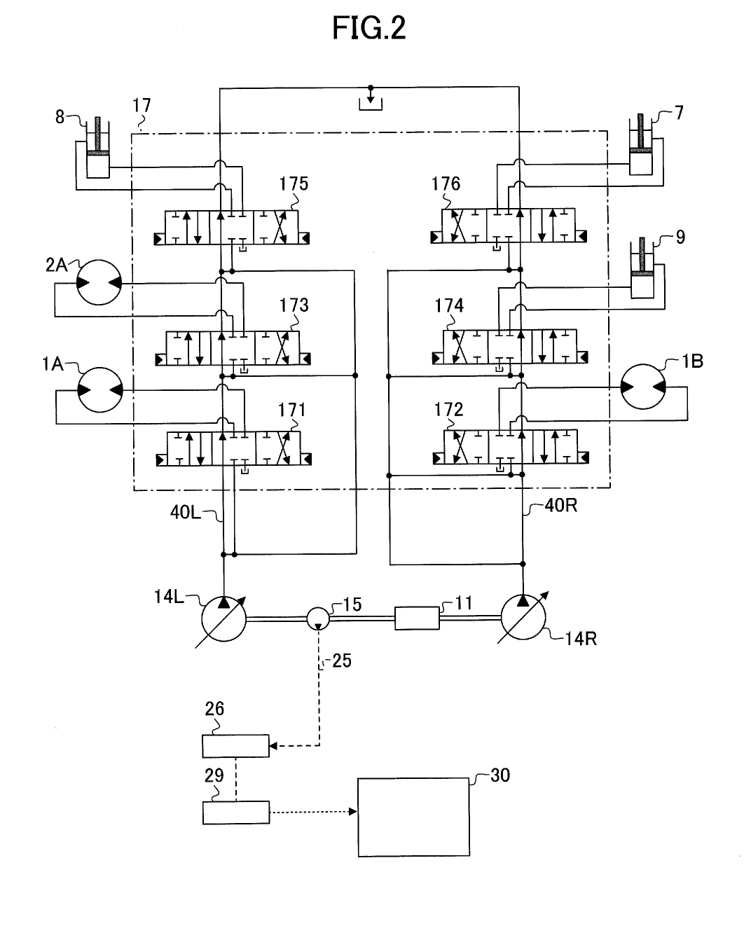

FIG. 2 is a diagram illustrating a configuration of a drive system installed in the shovel 50, indicating a mechanical drive transmission line, a hydraulic oil line, a pilot line, and an electrical control line by a double line, a solid line, a dashed line, and a dotted line, respectively.

The drive system of the shovel 50 includes the engine 11, main pumps 14L and 14R, a pilot pump 15, a control valve 17, an operating apparatus 26, a pressure sensor 29, and the controller 30.

The engine 11 is, for example, a diesel engine that operates to maintain a predetermined rotational speed. The output shaft of the engine 11 is connected to the input shafts of the main pumps 14L and 14R and the pilot pump 15.

The main pumps 14L and 14R are apparatuses for supplying hydraulic oil to the control valve 17 via hydraulic oil lines, and are, for example, swash-plate variable displacement hydraulic pumps.

The pilot pump 15 is an apparatus for supplying hydraulic oil to various hydraulic control apparatuses including the operating apparatus 26 via a pilot line 25, and is, for example, a fixed displacement hydraulic pump.

The control valve 17 is a hydraulic controller that controls the hydraulic system of the shovel 50. Specifically, the control valve 17 includes flow control valves 171 through 176 that control the flow of hydraulic oil discharged by the main pumps 14L and 14R. The control valve 17 supplies hydraulic oil discharged by the main pumps 14L and 14R selectively to one or more of the boom cylinder 7, the arm cylinder 8, the bucket cylinder 9, a left-side traveling hydraulic motor 1A, a right-side traveling hydraulic motor 1B, and a swing hydraulic motor 2A via the flow control valves 171 through 176. In the following description, the boom cylinder 7, the arm cylinder 8, the bucket cylinder 9, the left-side traveling hydraulic motor 1A, the right-side traveling hydraulic motor 1B, and the swing hydraulic motor 2A are collectively referred to as “hydraulic actuators.”

The operating apparatus 26 is an apparatus that the operator uses to operate the hydraulic actuators. According to this embodiment, the operating apparatus 26 supplies hydraulic oil discharged by the pilot pump 15 to the pilot port of each of the flow control valves 171 through 176 corresponding to the hydraulic actuators via the pilot line 25. The pressure of hydraulic oil (pilot pressure) supplied to each pilot port is a pressure commensurate with the direction of operation and the amount of operation of a lever or pedal of the operating apparatus 26 corresponding to a corresponding hydraulic actuator.

The pressure sensor 29 is an example of an operation contents detecting part to detect the contents of an operation by the operator using the operating apparatus 26. According to this embodiment, the pressure sensor 29 detects the direction of operation and the amount of operation of each lever or pedal of the operating apparatus 26 corresponding to one of the hydraulic actuators in the form of pressure, and outputs a detected value to the controller 30. The contents of an operation of the operating apparatus 26 may alternatively be derived using the output of a sensor other than the pressure sensor 29, such as a potentiometer.

A center bypass conduit 40L is a hydraulic oil line that passes through the flow control valves 171, 173 and 175 placed in the control valve 17. A center bypass conduit 40R is a hydraulic oil line that passes through the flow control valves 172, 174 and 176 placed in the control valve 17.

The flow control valve 171 is a spool valve that controls the flow rate and the flow direction of hydraulic oil among the main pump 14L, the left-side traveling hydraulic motor 1A, and a hydraulic oil tank. The flow control valve 172 is a spool valve that controls the flow rate and the flow direction of hydraulic oil among the main pump 14R, the right-side traveling hydraulic motor 1B, and the hydraulic oil tank. The flow control valve 173 is a spool valve that controls the flow rate and the flow direction of hydraulic oil among the main pump 14L, the swing hydraulic motor 2A, and the hydraulic oil tank.

The flow control valve 174 is a spool valve that controls the flow rate and the flow direction of hydraulic oil among the main pump 14R, the bucket cylinder 9, and the hydraulic oil tank. The flow control valve 175 is a spool valve that controls the flow rate and the flow direction of hydraulic oil among the main pump 14L, the arm cylinder 8, and the hydraulic oil tank. The flow control valve 176 is a spool valve that controls the flow rate and the flow direction of hydraulic oil among the main pump 14R, the boom cylinder 7, and the hydraulic oil tank.

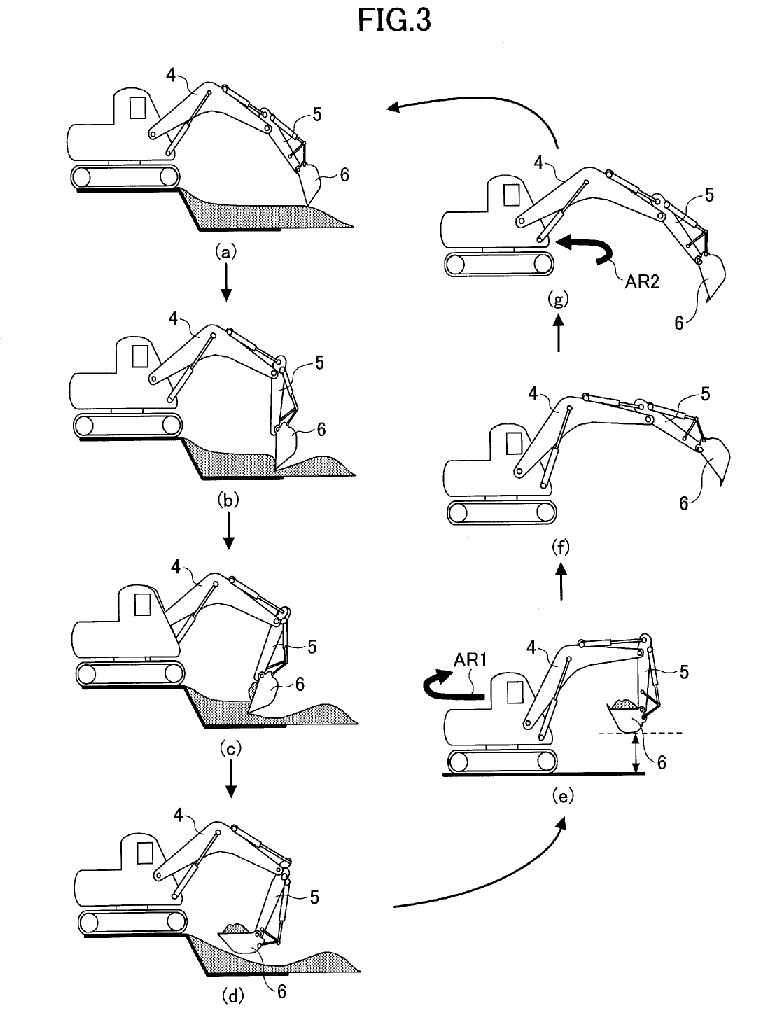

Next, an excavating and loading motion that is an example motion of the shovel 50 is described with reference to FIG. 3. First, as illustrated in (a) of FIG. 3, the operator swings (rotates) the upper rotating structure 3 and lowers the boom 4, with the arm 5 and the bucket 6 being open, so that the end of the bucket 6 is at a desired level above an excavating target. The operator visually checks the position of the bucket 6 when swinging the upper rotating structure 3 and lowering the boom 4. In general, the swinging of the upper rotating structure 3 and the lowering of the boom 4 are simultaneously performed. This motion is referred to as a boom lowering and swinging motion, and this motion section is referred to as a boom lowering and swinging motion section.

In response to determining that the end of the bucket 6 has reached the desired level, the operator closes the arm 5 so that the arm 5 is substantially perpendicular to the surface of earth, as illustrated in (b) of FIG. 3. As a result, the earth is dug for a predetermined depth. That is, the earth is scraped with the bucket 6 until the arm 5 is substantially perpendicular to the surface of the earth. Next, the operator further closes the arm 5 and the bucket 6 as illustrated in (c) of FIG. 3, and closes the bucket 6 so that the bucket 6 is substantially perpendicular to the arm 5 as illustrated in (d) of FIG. 3. That is, the operator closes the bucket 6 until the upper edge of the bucket 6 is substantially horizontal, and the scooped earth is accommodated in the bucket 6. This motion is referred to as an excavating motion, and this motion section is referred to as an excavating motion section.

Next, in response to determining that the bucket 6 is closed to be substantially perpendicular to the arm 5, the operator raises the boom 4 with the bucket 6 being closed so that the bottom of the bucket 6 is at a desired level above the surface of the earth as illustrated in (e) of FIG. 3. This motion is referred to as a boom raising motion, and this motion section is referred to as a boom raising motion section. Subsequent to or simultaneously with this motion, the operator swings the upper rotating structure 3 to swing and move the bucket 6 to an earth dumping position as indicated by arrow AR1. This motion including the boom raising motion is referred to as a boom raising and swinging motion, and this motion section is referred to as a boom raising and swinging motion section.

The boom 4 is raised until the bottom of the bucket 6 is at the desired level because, for example, the bucket 6 collides with the bed of a dump truck unless the bucket 6 is raised to be higher than the level of the bed when dumping earth onto the bed.

Next, in response to determining that the boom raising and swinging motion is completed, the operator opens the arm 5 and the bucket 6 to dump out earth inside the bucket 6 as illustrated in (f) of FIG. 3. This motion is referred to as a dumping motion, and this motion section is referred to as a dumping motion section. In the dumping motion, only the bucket 6 may be opened to dump out earth.

Next, in response to determining that the dumping motion is completed, the operator swings the upper rotating structure 3 as indicated by arrow AR2 to move the bucket 6 to immediately above an excavating position as illustrated in (g) of FIG. 3. At this point, at the same time with the swinging, the operator lowers the boom 4 so that the bucket 6 is lowered to a desired level above the excavating target. This motion is part of the boom lowering and swinging motion illustrated in (a) of FIG. 3. Thereafter, the operator lowers the bucket 6 to the desired level as illustrated in (a) of FIG. 3, and again performs the excavating motion and subsequent motions.

The operator proceeds with excavation and loading, repeatedly executing a cycle composed of the above-described “boom lowering and swinging motion,” “excavating motion,” “boom raising and swinging motion,” and “dumping motion.”

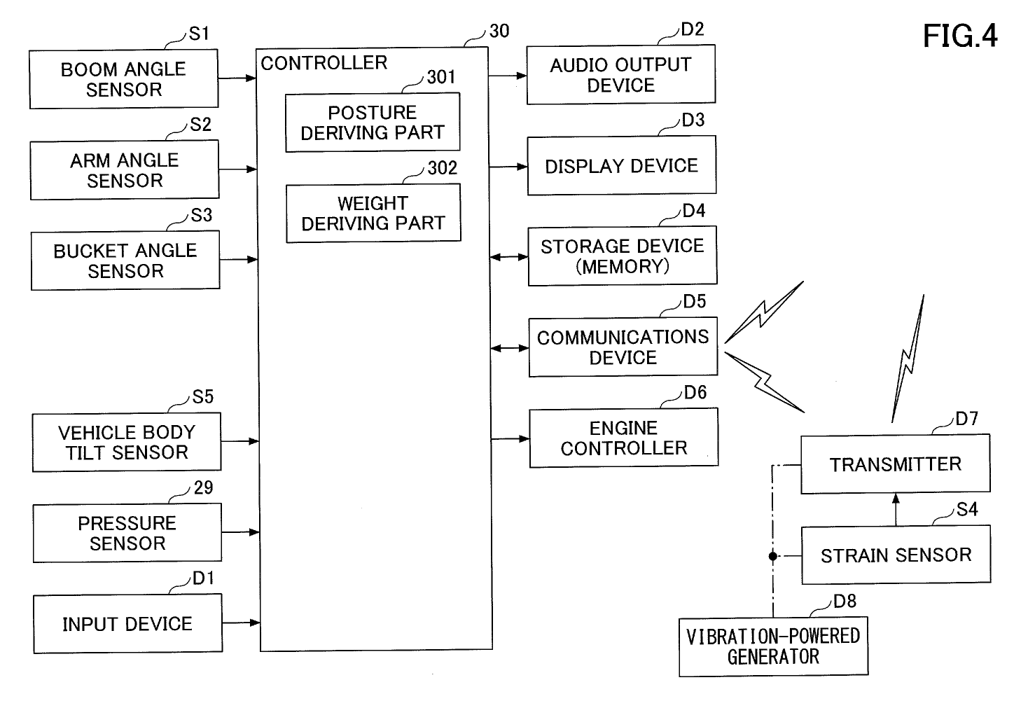

Next, various functions executed by the controller 30 are described with reference to FIG. 4. FIG. 4 is a diagram illustrating a configuration of the controller 30.

The controller 30 receives information from the boom angle sensor S1, the arm angle sensor S2, the bucket angle sensor S3, the strain sensor S4, the vehicle body tilt sensor S5, the pressure sensor 29, the input device D1, etc.

According to this embodiment, the controller 30 receives information via radio communications from the strain sensor S4 attached inside the boom 4. Specifically, the controller 30 receives information transmitted wirelessly by a transmitter D7 connected to the strain sensor S4, using the communications device D5 attached to the upper rotating structure 3.

The transmitter D7 wirelessly transmits a detection value of the strain sensor S4 to a device external to the strain sensor S4. According to this embodiment, the transmitter D7 is attached inside the boom 4 (an object of attachment) the same as the strain sensor S4. The transmitter D7 may alternatively be attached to the outside surface of the boom 4.

The strain sensor S4 and the transmitter D7 are connected to a vibration-powered generator D8, and are supplied with electric power from the vibration-powered generator D8.

The vibration-powered generator D8 converts vibration energy into electrical energy. According to this embodiment, the vibration-powered generator D8 is an electromagnetic induction generator, and is attached inside the boom 4 (an object of attachment) the same as the strain sensor S4 and the transmitter D7. The vibration-powered generator D8 may alternatively be an electrostatic induction generator or a piezoelectric generator, and may alternatively be attached to the outside surface of the boom 4.

The controller 30 executes various operations based on received information and information stored in the storage device D4, and outputs a control signal to the audio output device D2, the display device D3, the engine controller D6, etc., in accordance with the results of the operations. The controller 30 may wirelessly transmit information received via the communications device D5, the results of the operations, etc., to the outside.

The controller 30 includes a posture deriving part 301 that is a functional element to detect the posture of an attachment. According to this embodiment, the posture deriving part 301 derives the posture of the excavation attachment based on the output of the posture sensor composed of the boom angle sensor S1, the arm angle sensor S2, and the bucket angle sensor S3. The posture sensor may include the vehicle body tilt sensor S5. The controller 30 may receive information from the posture sensor through radio communications. Specifically, the same as in the case of the strain sensor S4, the controller 30 may receive information wirelessly transmitted by the transmitter D7 connected to the posture sensor, using the communications device D5 attached to the upper rotating structure 3. In this case, the posture sensor and the transmitter D7 may be connected to the vibration-powered generator D8 to be supplied with electric power from the vibration-powered generator D8.

The controller 30 includes a weight deriving part 302 that is a functional element to derive the weight of an object lifted by an attachment (hereinafter, “lift weight”). According to this embodiment, the weight deriving part 302 derives the lift weight based on the posture of the excavation attachment detected by the posture sensor and the strain of the excavation attachment detected by the strain sensor S4, when a predetermined deriving condition is satisfied.

For example, the weight deriving part 302 derives the lift weight, referring to a correspondence table using one or more of the strain of the excavation attachment, the posture of the excavation attachment, the shape of the excavation attachment, the position of attachment of the strain gauge, etc., as input keys. The correspondence table, which is a reference table that stores the correspondence relationship of, for example, the posture of the excavation attachment, the strain of the excavation attachment, and the lift weight, is prestored in the storage device D4. The correspondence relationship is predetermined based on a finite element method (FEM) analysis or the like. For example, the weight deriving part 302 selects the combination closest to a current combination of the posture and the strain of the excavation attachment from the correspondence table, and derives the value of the lift weight stored in correlation with the selected combination as a current lift weight. The strain of the excavation attachment means strain at one or more points in the excavation attachment.

The weight deriving part 302 may alternatively derive the lift weight by substituting a value pertaining to the strain of the excavation attachment and a value pertaining to the posture of the excavation attachment in a prestored calculation formula.

The “predetermined deriving condition,” which is a condition for determining the time for the weight deriving part 302 to derive the weight, includes, for example, “the lift-off of the bucket 6” (a first deriving condition”) and “the completion of a dumping motion” (a second deriving condition). Here, “the lift-off of the bucket 6,” namely, the detachment of the bucket 6 from the ground, is determined as the first deriving condition because it can be presumed that an object such as dirt is accommodated in the bucket 6 when the bucket 6 lifts off. Furthermore, “the completion of a dumping motion” is determined as the second deriving condition because it can be presumed that the bucket 6 is empty or that dirt that can be dumped is completely dumped when a dumping motion is completed.

For example, the controller 30 determines that the first deriving condition is satisfied in response to determining that a swing operation has been performed after an excavating motion. This is because it can be presumed that the bucket 6 is in the air when a swing operation is performed. Being “after an excavating motion” corresponds to being after the motion of (d) of FIG. 3. The controller 30 can determine whether it is in the state after an excavating motion from the posture of the excavation attachment and the strain of the excavation attachment detected by the strain sensor S4 attached inside the boom 4. For example, the controller 30 determines that the first deriving condition is satisfied in response to determining that a swing operation lever has been operated based on the output of the pressure sensor 29 after an excavating motion. The controller 30 may alternatively determine that a swing operation has been performed based on the outputs of two strain gauges one attached to each of the inside surfaces of both side plates of the boom 4.

The controller 30 may also determine that the first deriving condition is satisfied in response to determining that the boom 4 has risen to or above a predetermined height. This is because it can be presumed that the bucket 6 is in the air when the boom 4 has risen to or above a predetermined height. Specifically, the controller 30 may determine that the first deriving condition is satisfied in response to determining that the boom 4 has risen to or above a predetermined height based on the output of the boom angle sensor S1.

The controller 30 may also determine that the first deriving condition is satisfied in response to determining that the bucket 6 is closed to a predetermined angle. This is because it can be presumed that the bucket 6 is in the air when the bucket 6 is closed to a predetermined angle. Specifically, the controller 30 may determine that the first deriving condition is satisfied in response to determining that the bucket 6 is closed to a predetermined angle based on the output of the bucket angle sensor S3.

For example, the controller 30 determines that the second deriving condition is satisfied in response to determining that a swing operation has been performed during a dumping motion. This is because it can be presumed that a dumping motion is completed when a swing operation is performed. Specifically, the controller 30 determines that the second deriving condition is satisfied in response to determining that a swing operation lever has been operated based on the output of the pressure sensor 29 during a dumping motion.

The controller 30 may also determine that the second deriving condition is satisfied in response to determining that the bucket 6 is opened to a predetermined angle after the first deriving condition is satisfied. This is because it can be presumed that a dumping motion is completed when the bucket 6 is opened to a predetermined angle. Specifically, the controller 30 may determine that the second deriving condition is satisfied in response to determining that the bucket 6 is opened to a predetermined angle based on the output of the bucket angle sensor S3.

In response to deriving the lift weight, the weight deriving part 302 may output a control signal to at least one of the audio output device D2, the display device D3, the communications device D5, and the engine controller D6 in accordance with the result of the derivation. For example, the weight deriving part 302 may display information related to the lift weight on the display device D3 or output the information by voice through the audio output device D2. The weight deriving part 302 may wirelessly transmit information related to the lift weight to the outside via the communications device D5. The weight deriving part 302 may increase the output of the engine 11 via the engine controller D6 when the lift weight is a predetermined value or more.

The posture deriving part 301 and the weight deriving part 302 may alternatively be implemented by an external control device outside the shovel. The same as the controller 30, the external control device is a processor that includes a CPU and an internal memory. In this case, the controller 30 wirelessly transmits received information to the external control device via the communications device D5. The strain sensor S4 may wirelessly transmit a detection value to the external control device via the transmitter D7 or via the transmitter D7 and the communications device D5 of the controller 30.

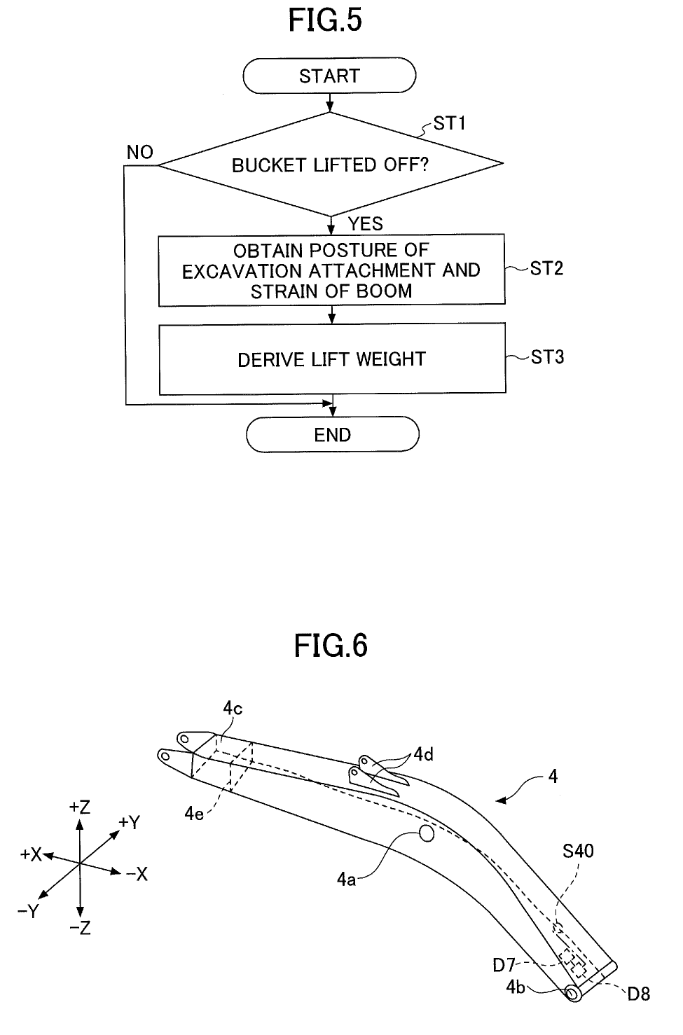

Next, a process of deriving the lift weight by the controller 30 (hereinafter, “weight deriving process”) is described with reference to FIG. 5. FIG. 5 is a flowchart of the weight deriving process. The controller 30 repeatedly executes this weight deriving process at predetermined control intervals.

First, at step ST1, the weight deriving part 302 of the controller 30 determines whether the bucket 6 has lifted off. According to this embodiment, the weight deriving part 302 determines that the bucket 6 has lifted off in response to the performance of a swing operation after an excavating motion. The weight deriving part 302 may alternatively determine whether the bucket 6 has lifted off based on the pressure of hydraulic oil in a hydraulic cylinder. The weight deriving part 302 may determine whether the bucket 6 has lifted off before operation of a swing operation lever after passage of a predetermined time (for example, two seconds) since operation of a boom operation lever in a raising direction. This is because strain due to a swing inertial force acts as noise once swinging starts.

In response to determining that the bucket 6 has not lifted off (NO at step ST1), the weight deriving part 302 repeats a determination as to whether the bucket 6 has lifted off once or more until determining that the bucket 6 has lifted off.

In response to determining that the bucket 6 has lifted off (YES at step ST1), at step ST2, the weight deriving part 302 obtains the posture of the excavation attachment and the strain of the boom 4. According to this embodiment, the weight deriving part 302 obtains the posture of the excavation attachment derived based on the output of the posture sensor by the posture deriving part 301. Furthermore, the weight deriving part 302 obtains the strain of the boom 4 based on the output of the strain sensor S4.

Thereafter, at step ST3, the weight deriving part 302 derives the lift weight. According to this embodiment, the weight deriving part 302 derives the weight of dirt or the like taken into the bucket 6 as the lift weight, referring to the correspondence table stored in the storage device D4, using the posture of the excavation attachment and the strain of the boom 4 as input keys.

Because of this configuration, the controller 30 can derive the load weight of dirt or the like loaded onto a dump truck (=the lift weight) with respect to each cycle of excavation and loading, for example. Furthermore, the controller 30 can also derive the total load weight of dirt loaded onto a single dump truck as workload by accumulating the load weights of individual cycles with respect to each dump truck. In addition, the controller 30 can derive excavation weight per predetermined time by accumulating the lift weights of individual cycles over the predetermined time. Therefore, the controller 30 can derive the amount of work by the excavation attachment with higher accuracy.

According to this embodiment, the controller 30 derives the lift weight based on the posture of the excavation attachment and the output of the strain sensor S4 at the time of determining that the bucket 6 has lifted off. Alternatively, the controller 30 may also derive the lift weight based on the posture of the excavation attachment and the output of the strain sensor S4 at multiple points of time after determining that the bucket 6 has lifted off during one cycle. In this case, the controller 30 may output the statistical value (such as the average, maximum, minimum, or intermediate value) of lift weights derived at multiple points of time after determining that the bucket 6 has lifted off as a final lift weight.

The controller 30 may continuously derive the lift weight while continuously obtaining the posture of the excavation attachment and the strain of the boom 4, irrespective of whether the bucket 6 has lifted off. In this case as well, the controller 30 may output, as a final lift weight, the lift weight at the time of determining that the bucket 6 has lifted off or the statistical value of lift weights derived at multiple points of time after determining that the bucket 6 has lifted off.

The controller 30 may determine the substance of work, such as excavation work, slope forming work, or subgrade digging work, based on a change in the posture of the excavation attachment. In this case, the controller 30 may correlate the determined work substance with workload subsequently derived to derive workload with respect to each work substance.

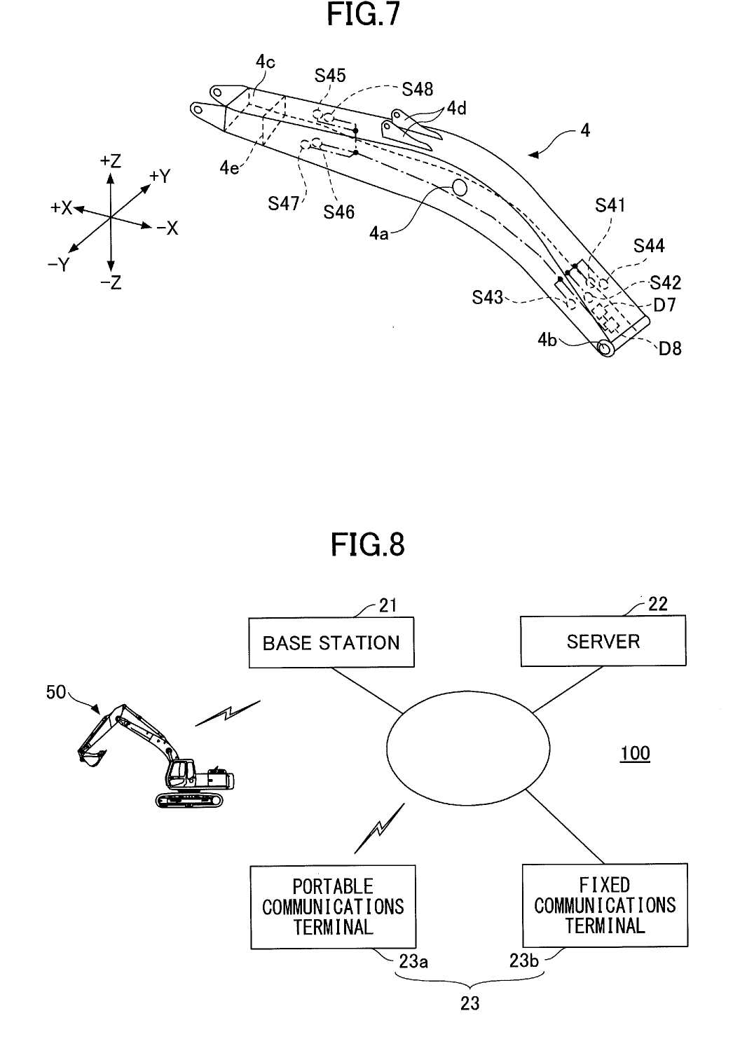

Next, attachment positions of the strain sensor S4, the transmitter D7, and the vibration-powered generator D8 in the boom 4 are described with reference to FIGS. 6 and 7. FIGS. 6 and 7 are perspective views of the boom 4. In the drawings, the one-dot chain line represents a power line, and the dashed line represents a hidden outline.

According to the embodiments illustrated in FIG. 6, a strain gauge S40 serving as the strain sensor S4 is attached to the inside surface of the back-side (+Z-side) metal plate of the boom 4 between a boom cylinder boss 4a and a boom foot 4b, in order to detect the strain of the boom 4 in a longitudinal direction (front-rear direction) of the boom 4. Specifically, the strain gauge S40 is attached to the center of the inside surface of the back-side metal plate of the boom 4. Alternatively, the strain gauge S40 may be attached to the inside surface of the front-side (−Z-side) metal plate of the boom 4 or to the inside surface of the back-side or front-side metal plate of the boom 4 between the boom cylinder boss 4a and a boom top 4c. The strain gauge S40 may be attached to a part of the inside surface other than the center. Even when attached to the inside surface of the back-side or front-side metal plate of the boom 4, the strain gauge S40 is so applied as to be able to calculate the tensile stress and compressive stress of the boom 4 in its longitudinal direction. The strain gauge S40 may alternatively be attached to a surface of a partition wall 4e in the boom 4. Thus, the strain gauge S40 is isolated from an external environment. The strain gauge S40 may be a three-axis strain gauge. In this case, the strain gauge S40 can detect strain in the X-axis direction, the Y-axis direction, and the Z-axis direction.

Because of this arrangement, the strain gauge S40 serving as the strain sensor S4 can detect, for example, the strain of the boom 4 due to the tension or compression of its back-side or front-side metal plate at the time of lifting dirt or the like with the excavation attachment. Furthermore, the strain gauge S40 can also detect strain due to tensile stress and strain due to compressive stress caused by a lifting load that acts on the excavation attachment (the boom 4). Therefore, the controller 30 can derive the lift weight even when only the single strain gauge S40 is applied on the inside surface of the back-side or front-side metal plate of the boom 4.

The transmitter D7 is attached to the inside surface of the back-side (+Z-side) metal plate of the boom 4 between the boom cylinder boss 4a and the boom foot 4b. Specifically, the transmitter D7 is attached to a left-side (−Y-side) part of the inside surface of the back-side (+Z-side) metal plate of the boom 4. Alternatively, the transmitter D7 may be attached to the inside surface of the front-side (−Z-side) metal plate of the boom 4 or to the inside surface of the back-side or front-side metal plate of the boom 4 between the boom cylinder boss 4a and the boom top 4c. The transmitter D7 may be attached to a part of the inside surface other than the left-side part. The transmitter D7 may alternatively be attached to a surface of the partition wall 4e in the boom 4. Thus, the transmitter D7 is isolated from an external environment.

The vibration-powered generator D8 is attached near the boom foot 4b because vibrations are more likely to be generated near the boom foot 4b than in other areas of the boom 4. Alternatively, the vibration-powered generator D8 may be attached to another area of the boom 4 where vibrations are likely to be generated, such as near the boom cylinder boss 4a or near brackets 4d. While being attached to the inside surface of the back-side (+Z-side) metal plate of the boom 4 according to this embodiment, the vibration-powered generator D8 may alternatively be attached to the inside surface of the front-side (−Z-side) metal plate of the boom 4 or to a surface of the partition wall 4e in the boom 4. Thus, the vibration-powered generator D8 is isolated from an external environment.

According to the embodiment illustrated in FIG. 7, the strain sensor S4 includes eight strain gauges S41 through S48. The strain gauges S41 through S48 are so applied as to be able to calculate the tensile stress and compressive stress of the boom 4 in its longitudinal direction. The arrangement of the transmitter D7 and the vibration-powered generator D8 is the same as in the embodiment illustrated in FIG. 6. The strain gauges S41 through S44 are attached to the inside surfaces of the back-side (+Z-side) metal plate, the front-side (−Z-side) metal plate, the left-side (−Y-side) metal plate, and the right-side (+Y-side) metal plate, respectively, of the boom 4 between the boom cylinder boss 4a and the boom foot 4b. The strain gauges S45 through S48 are attached to the inside surfaces of the back-side (+Z-side) metal plate, the front-side (−Z-side) metal plate, the left-side (−Y-side) metal plate, and the right-side (+Y-side) metal plate, respectively, of the boom 4 between the boom cylinder boss 4a and the boom top 4c. The strain gauges S43, S44, S47 and S48 are each attached to the center of the inside surface of the left-side or right-side metal plate of the boom 4.

According to the embodiment illustrated in FIG. 7, all of the eight strain gauges S41 through S48 are attached inside the boom 4. The number of strain gauges, however, may be less than or more than eight, and strain gauges may be attached to positions other than the inside of the boom 4. For example, all strain gauges may be attached inside the arm 5, or strain gauges may be distributed and attached inside the boom 4 and the arm 5. One or more strain gauges may be attached to a surface of the partition wall 4e in the boom 4 or a partition wall in the arm 5. Thus, the one or more strain gauges are isolated from an external environment.

The embodiment of FIG. 7, which uses the eight strain gauges S41 through S48, can detect the strain state of the excavation attachment with higher accuracy than the embodiment of FIG. 6 that uses the single strain gauge S40. Therefore, even during the operation of the excavation attachment, it is possible to detect the strain state of the excavation attachment with high accuracy.

By the above-described configuration, the shovel 50 makes it possible to supply electric power from the vibration-powered generator D8 attached to the boom 4 to the strain sensor S4 and the transmitter D7 attached to the boom 4, and can establish radio communications between the strain sensor S4 and the controller 30. Furthermore, the shovel 50 can dispense with a power line between the strain sensor S4 and a power source mounted on the upper rotating structure 3 and a battery for supplying electric power to the strain sensor S4. As a result, it is possible to stably measure the strain of the boom 4 in real time and over a long period of time, using the strain sensor S4.

Furthermore, by placing the strain sensor S4, the transmitter D7, and the vibration-powered generator D8 in the boom 4 to isolate the strain sensor S4, the transmitter D7, and the vibration-powered generator D8 from an external environment, the shovel 50 can more stably and more reliably measure the strain of the boom 4 using the strain sensor S4 at a work site.

Next, a communications network 100 to which the shovel 50 connects is described with reference to FIG. 8. FIG. 8 is a schematic diagram illustrating the communications network 100 to which the shovel 50 connects. The communications network 100 includes the shovel 50, a base station 21, a server 22, and communications terminals 23. The communications terminals 23 include a portable communications terminal 23a and a fixed communications terminal 23b. The base station 21, the server 22, and the communications terminals 23 can be interconnected using a communications protocol such as the Internet protocol. The number of shovels 50, the number of base stations 21, the number of servers 22, and the number of communications terminals 23 may be one or more. Examples of the portable communications terminal 23a include a notebook personal computer (PC), a cellular phone, and a smartphone. The communications terminals 23 may be hereinafter collectively referred to as “communications terminal 23” where a description is common to the communications terminals 23.

The base station 21 is a stationary facility that receives information wirelessly transmitted by the shovel 50, and transmits information to and receives information from the shovel 50 via, for example, satellite communications, cellular phone communications, or narrow area wireless communications.

The server 22 is an apparatus that stores and manages information wirelessly transmitted by the shovel 50, and is, for example, a computer that includes a CPU, a read-only memory (ROM), a random access memory (RAM), and an input/output (I/O) interface. Specifically, the server 22 obtains information received by the base station 21 via the communications network 100 and stores the obtained information. The server 22 manages the stored information so that an operator (a manager) can refer to the stored information as required.

The server 22 may configure various settings of the shovel 50 via the communications network. Specifically, the server 22 may wirelessly transmit values related to various settings of the shovel 50 to the shovel 50 to change settings-related values stored in the controller 30 of the shovel 50.

The server 22 may transmit various kinds of information to the communications terminal 23 via the communications network 100. Specifically, when a predetermined condition is satisfied or in response to a request from the communications terminal 23, the server 22 may transmit information related to the shovel 50 to inform an operator of the communications terminal 23 of the information related to the shovel 50.

The communications terminal 23 is a device that can refer to information stored in the server 22, and is, for example, a computer that includes a CPU, a ROM, a RAM, an I/O interface, an input device, a display, a loudspeaker, etc. For example, the communications terminal 23 may connect to the server 22 via the communications network 100 to allow the operator (manager) to view information related to the shovel 50. The communications terminal 23 may receive information related to the shovel 50 transmitted from the server 22 to allow the operator (manager) to view the received information.

According to this embodiment, the server 22 manages information related to the workload of the shovel 50 wirelessly transmitted by the shovel 50. Therefore, the operator (manager) can receive and view information related to the workload of the shovel 50 at any time through the communications terminal 23.

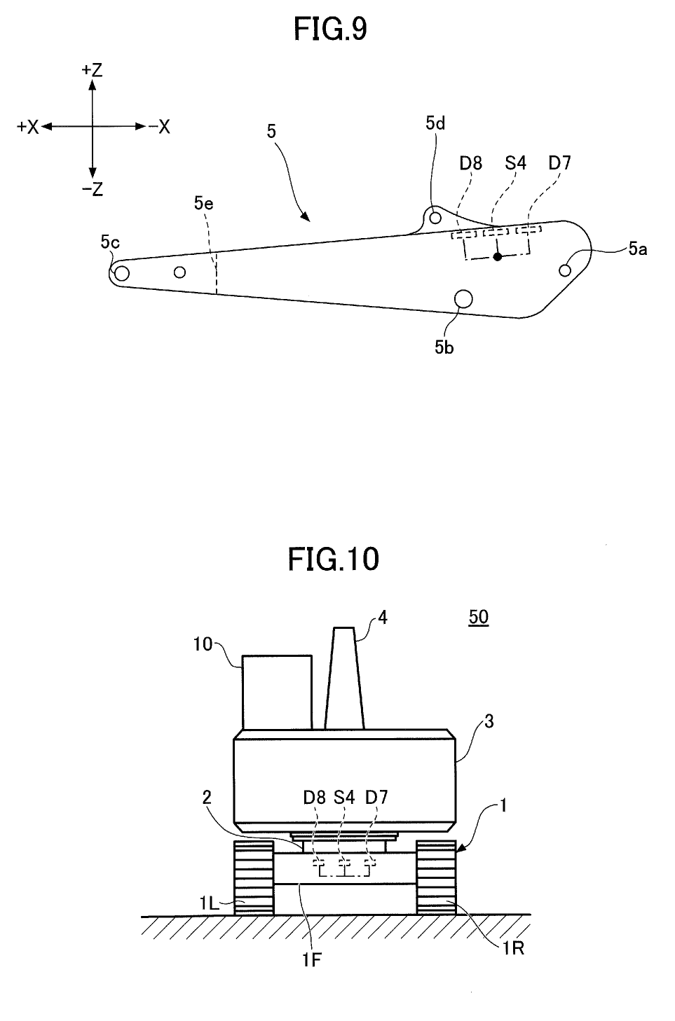

Next, attachment positions of the strain sensor S4, the transmitter D7, and the vibration-powered generator D8 in the arm 5 are described with reference to FIG. 9. FIG. 9 is a side view of the arm 5. In FIG. 9, the one-dot chain line represents a power line.

According to the embodiment illustrated in FIG. 9, the strain sensor S4 is attached to the inside surface of the back-side (+Z-side) metal plate of the arm 5 between an arm cylinder boss 5a and an arm foot 5b. Alternatively, the strain sensor S4 may be attached to the inside surface of the front-side (−Z-side) metal plate of the arm 5 or to the inside surface of the back-side or front-side metal plate of the arm 5 between the arm foot 5b and an arm top 5c.

Because of this arrangement, the strain sensor S4 can detect, for example, the strain of the arm 5 due to the tension or compression of its back-side or front-side metal plate at the time of lifting dirt or the like with the excavation attachment. Furthermore, the strain sensor S4 can detect strain due to tensile stress and strain due to compressive stress caused by a lifting load that acts on the excavation attachment (the arm 5).

The transmitter D7 is attached to the inside surface of the back-side (+Z-side) metal plate of the arm 5 between the arm cylinder boss 5a and the arm foot 5b. Alternatively, the transmitter D7 may be attached to the inside surface of the front-side (−Z-side) metal plate of the arm 5 or to the inside surface of the back-side or front-side metal plate of the arm 5 between the arm foot 5b and the arm top 5c.

The vibration-powered generator D8 is attached near brackets 5d because vibrations are more likely to be generated near the brackets 5d than in other areas of the arm 5. Alternatively, the vibration-powered generator D8 may be attached to another area of the arm 5 where vibrations are likely to be generated, such as near the arm cylinder boss 5a or near the arm foot 5b. While being attached to the inside surface of the back-side (+Z-side) metal plate of the arm 5 according to this embodiment, the vibration-powered generator D8 may alternatively be attached to the inside surface of the front-side (−Z-side) metal plate of the arm 5.

At least one of the strain sensor S4, the transmitter D7, and the vibration-powered generator D8 may be attached to a surface of a partition wall 5e in the arm 5 for isolation from an external environment.

By the above-described configuration, the shovel 50 can achieve the same effects as in the case of attaching the strain sensor S4, the transmitter D7, and the vibration-powered generator D8 to the boom 4.

Next, attachment positions of the strain sensor S4, the transmitter D7, and the vibration-powered generator D8 in the traveling undercarriage 1 are described with reference to FIG. 10. FIG. 10 is a rear view of the shovel 50. In FIG. 10, the one-dot chain line represents a power line.

According to the embodiment illustrated in FIG. 10, the strain sensor S4 is attached to the inside surface of the rear-side metal plate of a frame 1F of the traveling undercarriage 1 between a left crawler 1L and a right crawler 1R of the traveling undercarriage 1. Alternatively, the strain sensor S4 may be attached to any of the top-side inside surface, the bottom-side inside surface, the front-side inside surface, the left-side inside surface, and the right-side inside surface of the frame 1F.

Because of this arrangement, the strain sensor S4 can detect, for example, strain due to the tension or compression of the inside surface of the rear-side metal plate of the frame 1F at the time of lifting dirt or the like with the excavation attachment. Furthermore, the strain sensor S4 can detect strain due to stress caused by a bending load that acts on the traveling undercarriage 1.

The same as the strain sensor S4, the transmitter D7 is attached to the inside surface of the rear-side metal plate of the frame 1F. Alternatively, the same as the strain sensor S4, the transmitter D7 may be attached to any of the top-side inside surface, the bottom-side inside surface, the front-side inside surface, the left-side inside surface, and the right-side inside surface of the frame 1F. The strain sensor S4 and the transmitter D7 may be attached to different inside surfaces of the frame 1F. For example, the strain sensor S4 may be attached to the inside surface of the rear-side metal plate of the frame 1F, and the transmitter D7 may be attached to the inside surface of the left-side metal plate of the frame 1F.

The same as the strain sensor S4 and the transmitter D7, the vibration-powered generator D8 is attached inside the frame 1F. According to this embodiment, the vibration-powered generator D8 is attached to an area of the frame 1F near the swing mechanism 2 inside the frame 1F. This is because vibrations are more likely to be generated in this area than in other areas of the frame 1F. Alternatively, the vibration-powered generator D8 may be attached to another area of the frame 1F where vibrations are likely to be generated, such as an area of the frame 1F near the left crawler 1L or the right crawler 1R inside the frame 1F.

By the above-described configuration, the shovel 50 can achieve the same effects as in the case of attaching the strain sensor S4, the transmitter D7, and the vibration-powered generator D8 to the boom 4 or the arm 5.

All examples and conditional language provided herein are intended for pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority or inferiority of the invention. Although one or more embodiments of the present invention have been described in detail, it should be understood that the various changes, substitutions, and alterations could be made hereto without departing from the spirit and scope of the invention.

For example, while the electric power generated by the vibration-powered generator D8 is supplied to the strain sensor S4 and the transmitter D7 according to the above-described embodiments, the power may also be supplied to other electrical loads such as other sensors attached to the same object as are the strain sensor S4 and the transmitter D7.

The transmitter D7 and the vibration-powered generator D8 may be attached to an exhaust gas treatment apparatus, the main pump 14L or 14R, or the like placed at a distance from the controller 30, a power supply, etc. In this case, for example, the controller 30 may receive information wirelessly transmitted by the transmitter D7 connected to a temperature sensor, a concentration sensor, etc., attached to the exhaust gas treatment apparatus, using the communications device D5 attached to the upper rotating structure 3. The temperature sensor, the concentration sensor, etc., may be supplied with electric power from the vibration-powered generator D8.

The same is the case with sensors attached to the main pumps 14L and 14R. For example, the controller 30 may receive information wirelessly transmitted by the transmitter D7 connected to discharge pressure sensors attached to the main pumps 14L and 14R via the communications device D5. A control signal may be wirelessly transmitted from the communications device D5 to the transmitter D7 connected to regulators that control the amount of discharge of the main pumps 14L and 14R. The discharge pressure sensors, the regulators, etc., may be supplied with electric power from the vibration-powered generator D8. Thus, the transmitter D7 and the vibration-powered generator D8 may be attached to an apparatus mounted on the upper rotating structure 3. Furthermore, the vibration-powered generator D8 may include multiple vibration-powered generators attached to two or more of the boom 4, the arm 5, the frame 1F, and the upper rotating structure 3.

The strain sensor S4 and the transmitter D7 may be attached to the outside surface of a metal plate that forms part of the frame 1F of the traveling undercarriage 1, the outside surface of a metal plate that forms part of the boom 4, the outside surface of a metal plate that forms part of the arm 5, or the like. In this case, while being required to be covered with a covering or the like to be isolated from an external environment, the strain sensor S4 is provided with a battery and the transmitter D7 and can therefore transmit its detection value to the controller 30 of the shovel 50.

What is claimed is:

1. A shovel comprising:
an undercarriage;
a rotating structure mounted on the undercarriage;
an attachment attached to the rotating structure; and
a vibration-powered generator attached to one or more of the rotating structure, the undercarriage, and a work element of the attachment.

2. The shovel as claimed in claim 1, wherein the vibration-powered generator is attached near a bracket or a cylinder boss of the work element, or is attached to a frame of the undercarriage.

3. The shovel as claimed in claim 1, further comprising:
a strain sensor configured to detect strain of an object to which the strain sensor is attached,
wherein the vibration-powered generator is attached to the same object as the strain sensor, and is configured to supply electric power to the strain sensor.

4. The shovel as claimed in claim 3, further comprising:
a transmitter configured to wirelessly transmit a detection value of the strain sensor to an outside,
wherein the vibration-powered generator is configured to supply electric power to the transmitter.

5. The shovel as claimed in claim 4, wherein the transmitter is attached to the same object as the strain sensor.

6. The shovel as claimed in claim 3, wherein the vibration-powered generator and the strain sensor are attached to a surface of the object, and are covered with a covering to be isolated from an external environment.

7. The shovel as claimed in claim 1, wherein the work element includes one or both of a boom and an arm.

8. The shovel as claimed in claim 1, further comprising:
a posture sensor configured to detect a posture of an object to which the posture sensor is attached, and
the vibration-powered generator is attached to the same object as the posture sensor, and is configured to supply electric power to the posture sensor.

9. The shovel as claimed in claim 8, further comprising:
a transmitter configured to wirelessly transmit a detection value of the posture sensor to an outside, and
the vibration-powered generator is configured to supply electric power to the transmitter.
